(19) United States
(12) Patent Application Publication
(10) Pub. No.: US 2009/0204820 A1
(43) Pub. Date: Aug. 13, 2009

(54) Method and apparatus for Account Management

(76) Inventors: Wes G. Brandenburg, Underwood, IN (US); Gerald W. Rea, Scottsburg, IN (US); Robert A. Drake, Nashville, IN (US)

Correspondence Address: BAKER & DANIELS LLP, 300 NORTH MERIDIAN STREET, SUITE 2700, INDIANAPOLIS, IN, 46204, US

(21) Appl. No.: 12/322,269

(22) Filed: Jan. 30, 2009

Related U.S. Application Data
(60) Provisional application No. 61/024,882, filed on Jan. 30, 2008.
(60) Provisional application No. 61/050,950, filed on May 6, 2008.

(51) Int. Cl. G06F 21/00

(52) U.S. Cl. 713/182

(57) ABSTRACT

A method and apparatus for on-line account management controls access to a computer such as a web server. The method and apparatus reduces interference from Internet bots while minimizing the impact on a legitimate user's use of a web site.

### CROSS REFERENCE TO RELATED APPLICATIONS

This application claims the benefit of U.S. Provisional Patent Application Ser. No. 61/024,882, filed Jan. 30, 2008, titled METHOD AND APPARATUS TO LINK MEMBERS OF A GROUP, and U.S. Provisional Patent Application Ser. No. 61/050,950, filed May 6, 2008, titled METHOD AND APPARATUS TO LINK MEMBERS OF A GROUP, the disclosures of which are expressly incorporated by reference herein.

### BACKGROUND AND SUMMARY

The present invention relates to a method and apparatus for on-line account management to control access to a computer such as a web server. More particularly, the present invention provides a method and apparatus for reducing interference from Internet bots while minimizing the impact on a legitimate user's use of a web site.

Web sites, or Internet sites, provide information, products, and services to users. Often, such web sites require a user to set up a new account or otherwise enter certain information before a web server permits the user to access the web site. During account creation or registration, a user must typically complete an on-line electronic form to supply personal information such as username, account number, address, telephone number, e-mail address, age, gender, or the like to the registering web site.

Internet bots, also known as web robots or simply “bots”, are software applications that run automated tasks over a communication network such as the Internet. Bots perform tasks that are both simple and structurally repetitive at a much higher rate than would be possible for a human alone. While bots have many useful purposes, bots may also be used in harmful ways. For instance, bots can be used to complete web site account registration information to create thousands of new accounts in minutes. All these new accounts bog down the system for legitimate users. For instance, bots are often used to create bogus e-mail accounts and then use the bogus accounts to send spam e-mail messages.

Current bot prevention is dominated by two key technologies. A first technology is exemplified by PIX developed by Carnegie Mellon University where pictures of concrete items are shown to the user. The user must then answer the question, “What are these pictures of?” before the user is allowed to proceed with the on-line registration or request. A second technology is the use of a “CAPTCHA”. CAPTCHAs most often require users to enter words shown in a distorted image. However, CAPTCHAs are not limited to this technique. A CAPTCHA is any test that can be automatically generated which most humans can pass, but that current computer programs cannot pass.

The dynamic account management system and method disclosed herein retains this quality of a CAPTCHA while improving on current CAPTCHA technology. The illustrated account management system and method reduces the effectiveness of bots without creating additional work for people. A user of the present management system is not required to enter any extra fields or ponder frustrating distorted images.

The disclosed management system and method not only works for account sign ups, but also as a bot blocker throughout a site. The “test” of the present system and method in CAPTCHA parlance is the ability to understand instructions in plain English and fill out a form accordingly. This is something that humans do transparently, but computers are not capable of doing. Behind the scenes obfuscation and layout differences across accounts fool bots without hindering human users. More important than saving a user's time is saving them frustrating time. Some CAPTCHAs are simply too distorted or mangled for the average user to guess. In addition, the user may have vision problems. Some solutions are available to these problems such as requesting a new distorted image or provide an audio CAPTCHA. These solutions still result in moments of frustration that the present account management system and method eliminates.

In an exemplary embodiment of the present disclosure, a method is disclosed for managing access to at least one of accounts, information, products and services provided by a computer server to a plurality of computing devices communicating with the server over a network. The illustrated method includes receiving a request from a computing device at the server, and automatically identifying a plurality of form fields for an electronic form with the server in response to the request. The plurality of form fields allow a user of the computing device to input information for submission to the server. The method also includes automatically arranging the plurality of form fields in a random order with the server, automatically creating and sending the electronic form including the plurality of form fields arranged in the random order from the server to the computing device, receiving a plurality of inputs corresponding to the plurality of form fields from the computing device at the server, and automatically determining with the server whether the plurality of inputs corresponding to the plurality of form fields received from the computing devices are valid.

In an illustrated embodiment, the method further includes automatically assigning a randomly generated name to each of the plurality of form fields with the server, automatically mapping and storing the randomly generated names to the corresponding form fields in a memory of the server, and using the mapped randomly generated names during the step of automatically determining with the server whether the plurality of inputs corresponding to the plurality of form fields received from the computing device are valid.

In another illustrated embodiment, the plurality of forms fields have an associated instruction. In one embodiment, an order of the instructions is automatically arranged by the server to match the random order of the form fields during the step of automatically creating and sending the electronic form from the server to the computing device. In another embodiment, a visual indicator is provided by the server to link the form fields to the corresponding instructions on a display of the computing device.

In yet another illustrated embodiment, each form field has a corresponding computer code for generating the electronic form. The method further includes shuffling an order of the corresponding computer code with the server so that a displayed order of the form fields on the computing device is different than an order of the computer code corresponding to the form fields.

In another exemplary embodiment of the present disclosure, a method is disclosed for managing access to at least one of accounts, information, products and services provided by a computer server to a plurality of computing devices communicating with the server over a network. The method includes receiving a request from a first computing device at the server, and automatically creating and sending an electronic form from the server to the first computing device in response to the request received from the first computing device. The electronic form includes a plurality of form fields arranged in a first order. The method also includes receiving a request from a second computing device at the server, and automatically creating and sending the electronic form from the server to the second computing device in response to the request received from the second computing device, the electronic form having the same plurality of form fields arranged in a second order different from the first order. The method further includes receiving a plurality of inputs corresponding to the plurality of form fields from the first and second computing devices at the server, and automatically determining with the server whether the plurality of inputs corresponding to the plurality of form fields received from the first and second computing devices are valid.

In yet another exemplary embodiment of the present disclosure, a system is disclosed for managing access to at least one of accounts, information, products and services by a plurality of computing devices which are connectable to a network. The system includes a computer server operatively connected to the plurality of computing devices through the network, a memory accessible by the server, and at least one access management application stored in the memory. The at least one access management application controls the server to automatically identify a plurality of form fields for an electronic form in response to a request from a computing device, the plurality of form fields allowing a user of the computing device to enter information for submission to the server, to automatically arrange the plurality of form fields in a random order, to automatically create and send the electronic form from the server to the computing device, the electronic form including the plurality of form fields arranged in the random order, to receive a plurality of inputs corresponding to the plurality of form fields from the computing device, and to automatically determine whether the plurality of inputs corresponding to the plurality of form fields received from the computing devices are valid.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a block diagram illustrating communication between a plurality of computing devices and a server over a communication network;

FIG. 2 is a block diagram illustrating components of a representative computing device;

FIG. 3 is a block diagram illustrating certain functions controlled by an account management software application used by the server;

FIG. 4 is a flowchart illustrating steps performed by the computing device and the server during operation of the dynamic account management application of the present disclosure;

FIG. 5 is an illustrated electronic form which must be completed to set up a new account;

FIG. 6 is another version of the form of FIG. 5 which in certain form fields and instructions have been shuffled to new locations on the form;

FIG. 7 is an example of a human user completing a portion of a form;

FIGS. 8-10 are examples illustrating a bot attempting to complete a form which has been modified to block the bots by the present account management application; and

FIG. 11 is an example of how a randomly organized code for generating an electronic form is reorganized so that the form looks the same to the user regardless of the random order of the underlying code.

### DETAILED DESCRIPTION OF THE DRAWINGS

For the purposes of promoting an understanding of the principles of the invention, reference will now be made to certain illustrated embodiments and specific language will be used to describe the same. No limitation of the scope of the claims is thereby intended. Such alterations and further modifications of the invention, and such further applications of the principles of the invention as described and claimed herein as would normally occur to one skilled in the art to which the invention pertains, are contemplated, and desired to be protected.

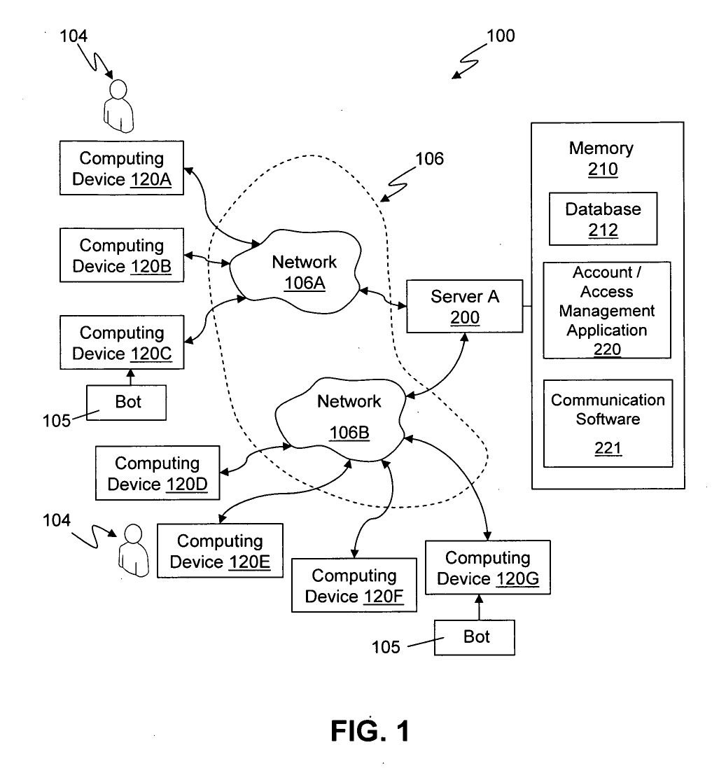

FIG. 1 illustrates a system 100 in which a plurality of computing devices 120A-120G communicate with a server 200 through an electronic communication network 106. Reference number 120 used herein may refer to any of the plurality of computing devices 120A-120G. Computing device 120 may be a general purpose computer or a portable computing device. Although computing device 120 is illustrated as a single computing device, it should be understood that multiple computing devices may be used together, such as over a network or other methods of transferring data. Exemplary computing devices include desktop computers, laptop computers, personal data assistants (“PDAs”), cellular devices, tablet computers, or other devices capable of the communications discussed herein.

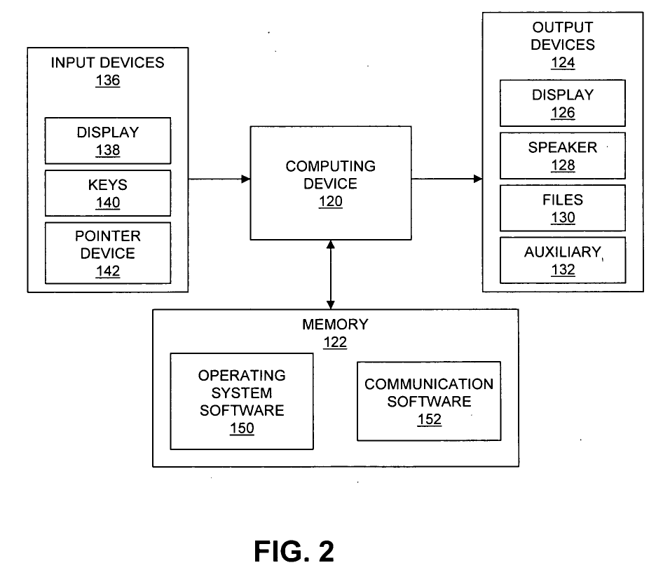

As shown in FIG. 2, computing device 120 has access to a memory 122. Memory 122 is a computer readable medium and may be a single storage device or multiple storage devices, located either locally with computing device 120 or accessible across a network. Computer-readable media may be any available media that can be accessed by the computing device 120 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 120.

Computing device 120 also has access to one or more output devices 124. Exemplary output devices 124 include a display 126, a speaker 128, a file 130, and an auxiliary device 132. Exemplary auxiliary devices 132 include devices which may be coupled to computing device 120, such as a printer. Files 130 may have various formats. In one embodiment, files 130 are formatted for display by an Internet browser, and may include one or more of HyperText Markup Language (“HTML”), or other formatting instructions. In one embodiment, files 130 are files stored in memory 122 for transmission to another computing device and eventual presentation by another output device or to at least to influence information provided by the another output device.

Computing device 120 further has access to one or more input devices 136. Exemplary input devices 136 include a display 138 (such as a touch display), keys 140 (such as a keypad or keyboard), a pointer device (such as a mouse, a roller ball, a stylus), and other suitable devices by which an operator may provide input to computing device 120.

Memory 122 includes an operating system software 150. Memory 122 further includes communications software 152. Exemplary communications software 152 includes e-mail software, Internet browser software, and other types of software which permit computing device 120 to communicate with other computing devices across a network 106. Exemplary networks include a local area network, a cellular network, a public switched network, and other suitable networks. An exemplary public switched network is the Internet.

Referring to FIG. 1, both human users 104 and web robots or bots 105 are shown with an associated computing device 120. Of course, a given user 104 or bot 105 may have multiple computing devices 120 through which the user 104 or bot 105 may access a computing device 200 which provides information and/or manages account creation. As illustrated, network 106 is shown including a first network 106A and a second network 106B. For example, computing devices 120A-120C may be handheld devices which communicate with computing device 200 through a cellular network 106A while computing devices 120D-120G are computers which communicate with computing device 200 through a public switched network, such as the Internet. In one example, computing devices 120A-120C may also communicate with computing device 200 through the Internet, in that the provider of cellular service provides a connection to the Internet.

Computing device 200 is labelled as Server because it serves or otherwise makes available to computing devices 120A-120G various applications, information, products or services. In one embodiment, computing device 200 is a web server and the various applications are web sites which are served by computing device 200. Although a single server 200 is shown, it is understood that multiple computing devices are often implemented to function as the illustrated server 200.

Computing device 200 has access to a memory 210. Memory 210 is a computer readable medium and may be a single storage device or multiple storage devices, located either locally with computing device 200 or accessible across a network. Computer-readable media may be any available media that can be accessed by the computing device 200 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 200.

In addition to one or more applications, memory 210 stores one or more databases 212 which are used by the applications. In one embodiment, databases 212 are stored in a MySQL database system available from MySQL AB, a subsidiary of Sun Microsystems Inc, located in Cupertino, Calif. Memory 210 also includes an account or access management application 220. Memory 210 further includes communications software 221. Exemplary communications software 221 includes e-mail software, web server software, and other types of software which permit server 200 to communicate with computing devices 120 across the network 106.

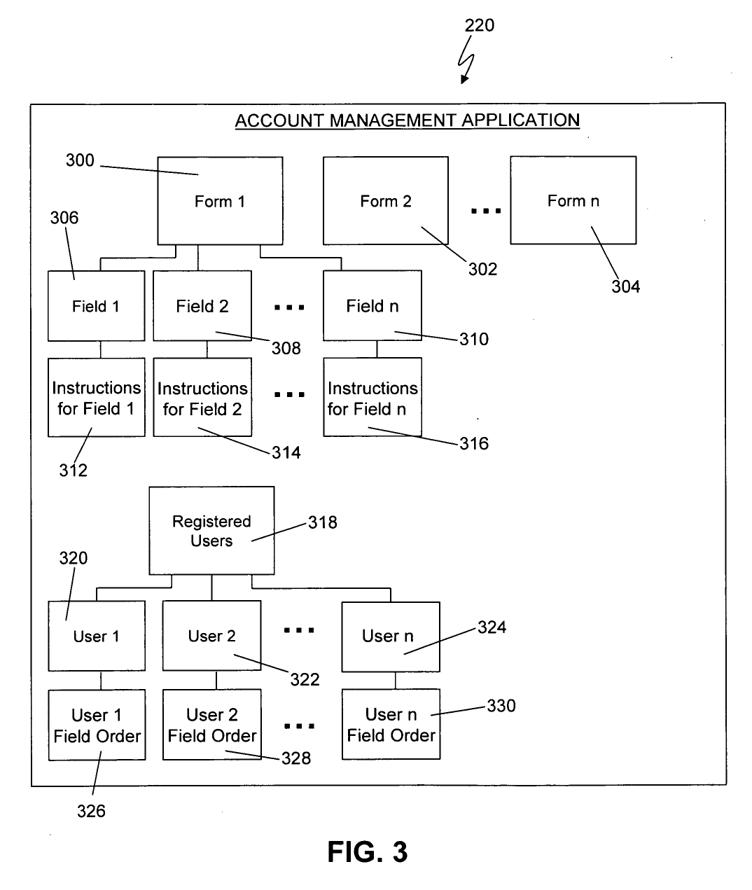

FIG. 3 illustrates additional details of the account/access management application 220. As discussed above, web sites often require a user to set up a new account or enter certain information before the web server 200 permits the user to access the web site. Also, when requesting services such as ordering tickets or requesting other information, the web site often requires an electronic form to be completed by the user. Therefore, the management application 220 may include a plurality of different forms 300, 302, 304 used throughout a web site based upon the specific account to be established or service requested. Each of forms 300, 302, 304 includes a plurality of different data entry fields. For example, form 1 at block 300 includes a plurality of fields 1, 2, . . . n illustrated at blocks 306, 308 and 310. Forms 2 through n illustrated at blocks 302 and 304 also include a plurality of different fields (not shown) Any desired number of fields may be provided for each form 300, 302, 304. Form fields 306, 308 and 310 are elements that allow the user 104 or bot 105 to enter information. Examples of form fields include, but are not limited to text fields, text area fields for larger amounts of text, drop-down menus, radio buttons, and checkboxes in a form. Of course, other varieties of form fields may be used as well. The techniques described herein may be applied to any type of field within a form.

The account/access management application 220 may also provide instructions to the user related to each field of the form. The instructions for fields 1, 2, . . . n are linked to the associated fields as illustrated at blocks 312, 314 and 316 so that the instructions 312, 314, 316 are displayed adjacent the fields 306, 308, 310 respectively. The management application 220 also stores information such as an identification number or account number for registered users as illustrated at block 318 and discussed in more detail below.

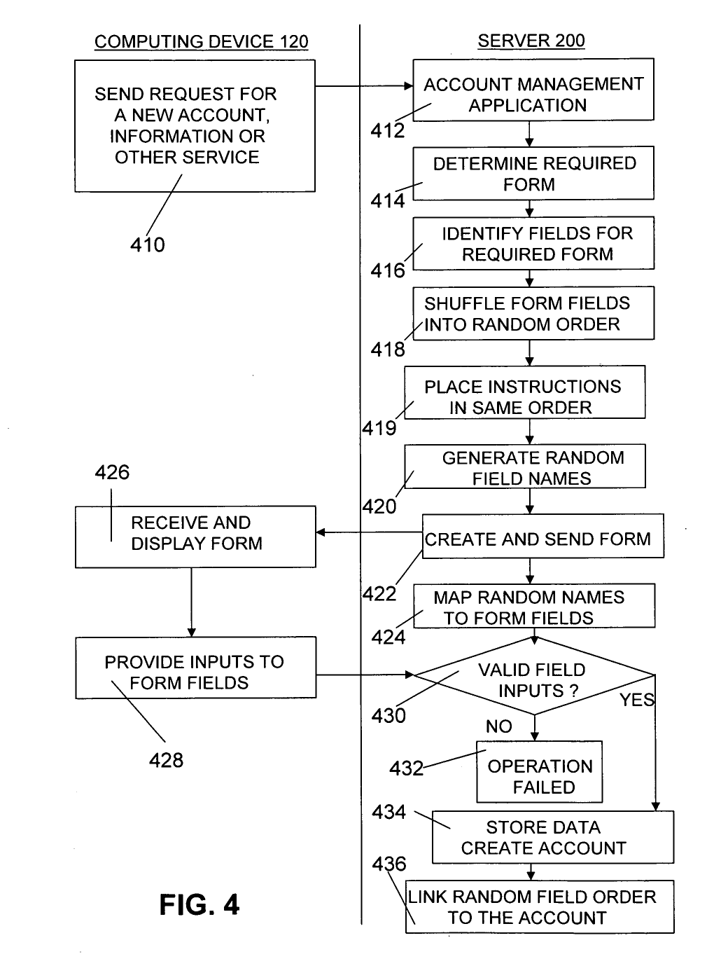

FIG. 4 is a flowchart illustrated the steps performed by one of the computing devices 120 and the server 200 during a request to open a new account or request for other information or services. First, computing device 120 sends a request to create a new account or to provide information or other service to the server 200 via the communication network 106 as illustrated at block 410. Server 200 uses the account management application 220 to process the request received from the computing device 120 as illustrated at block 412. The request may be either from a human user 104 or a software application such as a bot 105. Server 200 next determines a required form based on the request as illustrated at block 414. As discussed above, a plurality of different forms 300, 302 . . . 304 may be used. Next, server 200 identifies the fields associated with the required form as illustrated at block 416. For instance, if form 1 at block 300 of FIG. 3 is the required form, the server 200 identifies fields 1 through n illustrated at blocks 306, 308 and 310 as the fields associated with form 1.

Next, in order to reduce the likelihood that bots 105 may create a new account, or obtain access to information or other services, server 200 shuffles the identified form fields into a random order as illustrated at block 418. Server 200 then arranges any instructions associated with the fields in the same random order as the fields as illustrated at block 419 and discussed above with reference to FIG. 3. Therefore, the instructions for each field are displayed properly on the computing device 120 for review by a user 104.

In an illustrated embodiment, a list a fields needed for a given form is produced. The fields are placed randomly within the HTML using a Randomizer. In one embodiment, the new order is used by the server to dynamically create a Cascading Style Sheets (CSS) that positions the fields and instructions into the desired order. While bots may look at CSS, they generally don't need to, so few bots understand CSS. As bots become smarter and do start looking at the CSS, the present system and method will still be confusing because of frequent changes due to the dynamic generation discussed herein. The generator may be augmented on a regular basis to make it more confusing or confusing in a different way, to stay ahead of bots.

In one illustrated embodiment, form fields that are placed randomly in the HTML file using the randomizer are displayed properly using a dynamically generated CSS. The CSS keeps the fields and instructions in a layout comprehensible to a human user, but not to a bot.

Next, server 200 generates random field names for the identified fields as illustrated at block 420. Server 200 then creates and sends the form from the server 200 to the computing device 120 via communication network 106 as illustrated at block 422. Server 200 then maps or links the randomly generated field names to the correct form fields as illustrated at block 424 and stores this information in database 212 or memory 210.

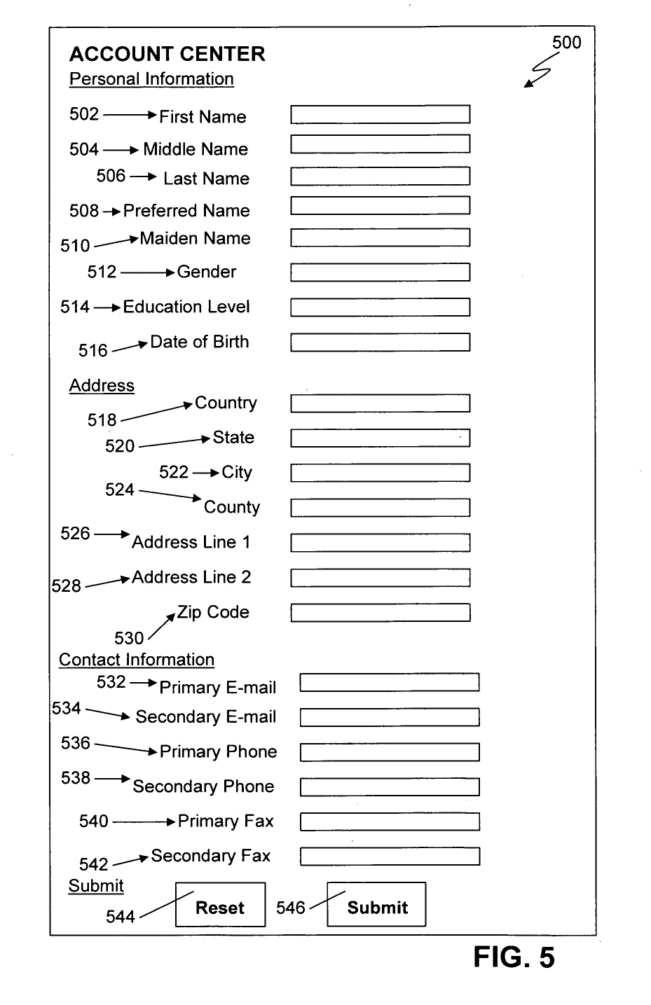

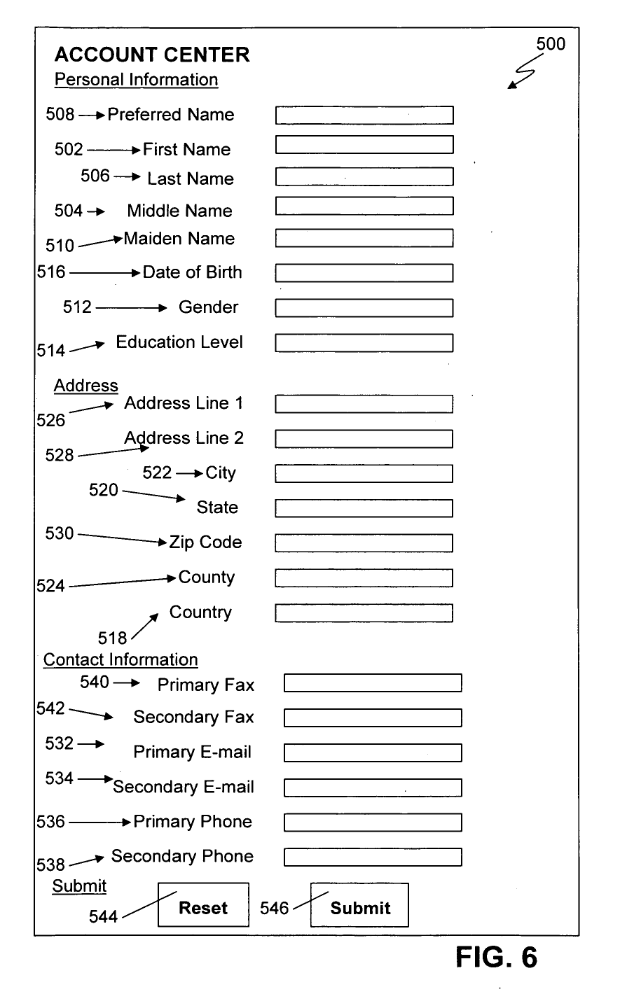

Computing device 120 receives and displays the form as illustrated at block 426. As discussed below with reference to FIGS. 5 and 6, the fields of the form are in a random order and are not repeated in the same order each time a computing device 120 requests the new account, information or other service from the server 200. Instructions for the fields are displayed on the computing device 120 in the same order as the fields. The user 104 or bot 105 then provides inputs to the form fields as illustrated at block 428. These field inputs are transmitted back to the server via the communication network 106.

Server 200 then determines whether the field inputs are valid as illustrated at block 430. Server 200 uses the random names mapped to the specific form fields to determine the validity of the inputs as discussed in more detail below. The plurality of inputs corresponding to the plurality of form fields received from the computing device 120 are determined to be invalid by the server 200 if at least one input has an input characteristic that is different from an expected input characteristic for a corresponding form field. If the inputs are invalid at block 430, the operation fails as illustrated at block 432. Such invalid information is often entered by a bot 105. Therefore, the account management application 220 blocks access to the regenerated information by the bots 105.

If the inputs received from computing device 120 are valid at block 430, the server 200 creates a new account and stores the user inputs provided for the form fields as illustrated at block 434. The plurality of inputs corresponding to the plurality of form fields received from the computing device 120 are determined to be valid by the server 200 if the plurality of inputs have input characteristics that match expected input characteristics for corresponding form fields. Server 200 then links the random field order to the account identification as illustrated at block 436. This feature is illustrated in FIG. 3. The account management application 220 stores a list of registered users 318 in the database. Users 1, 2, . . . n are illustrated at boxes 320, 322 and 324, respectively. Server 200 maps or otherwise links the random field order for certain forms sent to the registered users as illustrated at boxes 326, 328 and 330, respectively. Therefore, the next time the same user accesses the account and requires the same form, the form may be provided to the user with fields arranged in the same order that the user saw previously in order to avoid confusion and provide uniformity.

FIG. 5 illustrates an example of an account center for setting up a new account via a web site. The illustrated form 500 includes a plurality of fields including a first name field 502, a middle name field 504, a last name field 506, a preferred name field 508, a maiden name field 510, a gender field 512, an education level field 514, and a date of birth field 516. An “Address” section of the form 500 illustratively includes a country field 518, a state field 520, a city field 522, a county field 524, an address line 1 field 526, an address line 2 field 528, and a zip code field 530. A “Contact Information” section of the form 500 includes a primary e-mail field 532, a secondary e-mail field 534, a primary phone number field 536, a secondary phone number field 538, a primary fax field 540, and a secondary fax field 542. Illustratively, the form also includes a reset button 544 and a submit button 546 which may be selected by the user once the information is input into the form 500. The reset button 544 clears all the fields. The submit button 546 transmits the completed user inputs from the remote computing device 120 to the server 200 as discussed above. The illustrated fields of FIG. 5 are merely examples and are not required fields.

As discussed above in connection with FIG. 4, when different users 104 or bots 105 send a request for a new account or other information, the fields of form 500 are shuffled into a different random order to reduce the likelihood that bots 105 will be successful in completing form 500. FIG. 6 shows form 500 with the fields shuffled into a random order when requested by another user 104 or bot 105. Certain fields should remain next to each other. For instance, address line 1 field 526 and address line 2 field 528 should remain adjacent each other and in the same order. However, these fields 526 and 528 can change position with other fields within the address section of form 500 as illustrated in FIGS. 5 and 6.

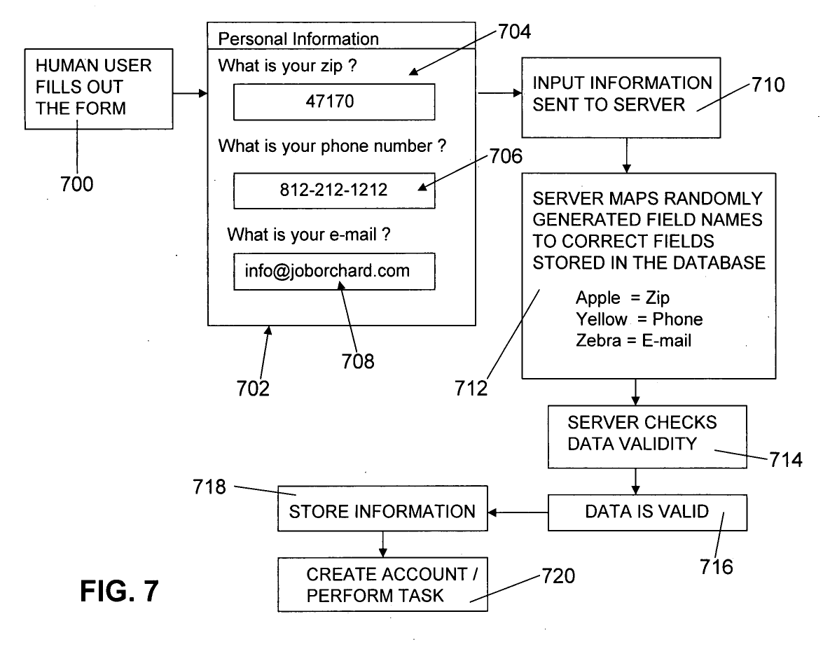

FIGS. 7-10 illustrate operation of the account management system and method when server 200 is accessed by human users 104 and bots 105. In FIG. 7, a human user 104 uses a computing device 120 to complete a form as illustrated at block 700. The form illustrated at block 702 includes a plurality of input fields 704, 706, and 708 which are arranged in a random order as discussed above with reference to FIG. 4. Instructions 705, 707, 709, are located adjacent fields 704, 706, 708, respectively. The human user 104 is able to read the random order instructions and enter the correct information into form 702 as shown in FIG. 7.

The input information is then sent to the server 200 as illustrated at block 710. The server 200 then uses the maps or links of the randomly generated field names to the correct field names discussed above at block 424 as shown at block 712. In the illustrated embodiment, the randomly generated field name for the zip code field is “apple”. The randomly generated name for the phone field is “yellow”, and the randomly generated field name for the e-mail field is “zebra”. Using the illustrative example of FIG. 7, the random field names are used in the form's HTML. Therefore, the id of the zip code field is “apple”, the id of the phone number field is “yellow”, and the id of the email field is “zebra”.

Next, server 200 checks the validity of data received at block 714. Since the human user 104 correctly completed the form 702, the data is determined to be valid at block 716. The server 200 then stores the submitted information as illustrated at block 718. In addition to the information, the server 200 stores the order that the fields 704, 706, and 708 were presented to the particular user so that the fields can be presented in the same order if form 702 is requested or required by the same user in the future. The server 200 then proceeds with creating an account or performing the requested service such as providing information or access to an application by the user 104 as illustrated at block 720.

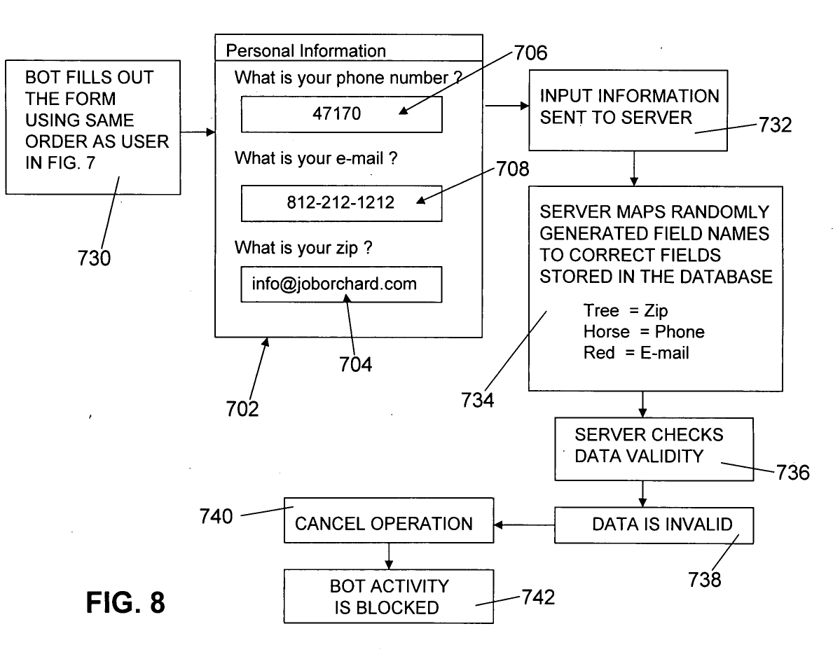

FIG. 8 illustrates steps performed when a bot 105 attempts to complete the form 702 using the same field order used by the human user 104 in FIG. 7 as illustrated at block 730. In the FIG. 8 embodiment, the order of fields 704, 706 and 708 on form 702 is different from the order in FIG. 7 due to the random order selection discussed above. In addition, the randomly generated field names in the FIG. 8 embodiment are different. For example, the zip code field is named “tree”, the phone field is named “horse” and the e-mail field is named “red”.

After the bot 105 completes form 702 using the same field order as FIG. 7, the input information is sent to the server as illustrated at block 732. Next, the server 200 maps randomly generated filed names to the correct field names stored in the database as illustrated at block 734. Server 200 then checks the validity of the data as illustrated at block 736. Since the wrong information was entered in the form 702, the data is invalid at block 738. Therefore, the operation is cancelled at block 740 which blocks the requested activity of the bot 105 as illustrated at block 742.

Although the display locations of the form fields in FIG. 8 is different from the locations in FIG. 7, and that is generally the case, the different locations are not required. While display location of fields will generally be consistent for any one user (unless bot activity is suspected) in order to minimize confusion, the display locations of the same form may be different for a different user. Therefore, if a bot switches accounts after being detected, the different locations of the form fields will present a new challenge to the bot. While the field locations and names in the HTML file are typically randomized with each page load, certain forms may keep the same display locations for everyone. Some forms will change the display locations of the fields for each user. Some forms may keep the same display locations of the fields only across a certain group of users, such as all the students in one classroom, to make it easier for a teacher to instruct the students as a group.

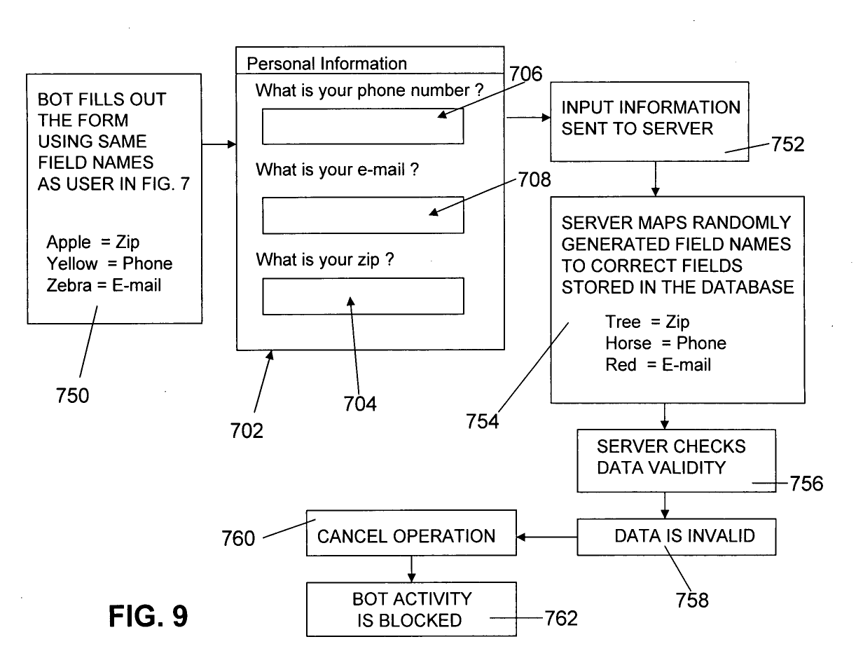

FIG. 9 illustrates an example when a bot 105 fills out form 702 using the same field names assigned in form 702 in the FIG. 7 embodiment as illustrated at block 750. However in FIG. 9, the fields have been assigned different, randomly generated field names compared to the FIG. 7 embodiment. Illustratively, FIG. 9 uses the same field names as FIG. 8. Therefore, when looking at the underlying HTML file for the words “apple”, “yellow”, and “zebra” these names are not found. Instead the names “tree”, “horse”, and “red” were used for the field names. Therefore, the bot 105 is unable to complete the form 702 as illustrated in FIG. 9. The fields 704, 706, and 708 may be only a portion of the fields on form 702.

Bot 105 sends the input information to the server is illustrated at block 752. The server 200 maps the randomly generated field names to the correct field name stored in the database as illustrated at block 754. Server 200 then checks the validity of the data at block 756. Since at least portions of the data are missing, the data is found invalid at block 758. Therefore the operation is cancelled at block 760 which blocks the activity of the bot 105 as illustrated at block 762.

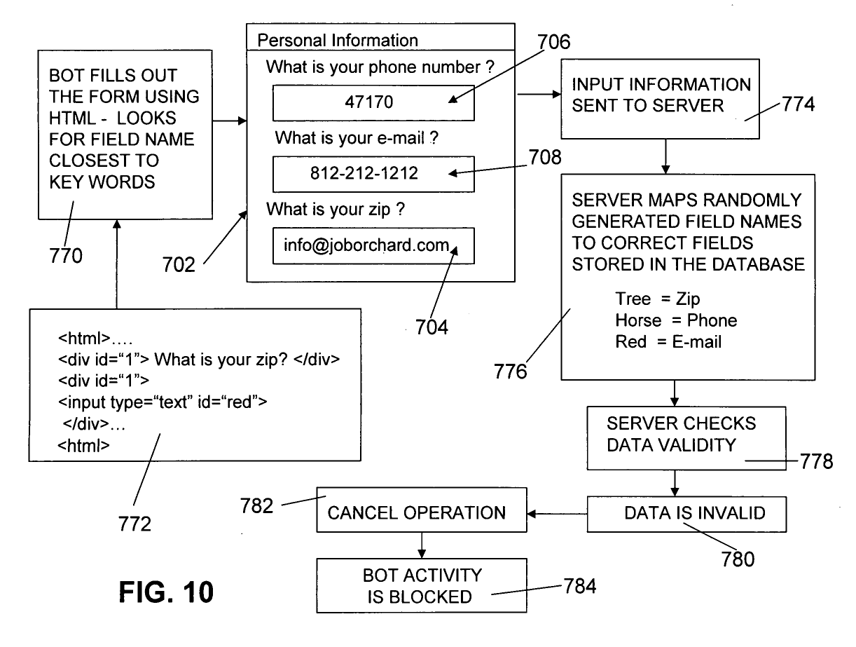

Yet another example is illustrated in FIG. 10. In this embodiment, the bot 105 fills out the form 702 by looking for field names closest to keywords in the HTML file as illustrated at block 770. Portions of the HTML are shown at block 772. Bot 105 searches the HTML file and locates the question, “What is your zip?”. The field name adjacent this question in the HTML file is “red”. However, “red” is the actual field name for the e-mail field and not the zip code field. The locations of the field names in the HTML file are randomly placed adjacent different fields to confuse the bots 105.

Since the names closest to the particular question or instruction are not the names for those fields, the bot 105 inputs the wrong information into fields 704, 706, and 708 of form 702. The input information is sent to the server as illustrated at block 774. Server then maps the randomly generated field names to the correct field names stored in the database as illustrated at block 776. Server 200 then checks the validity of the data as illustrated at block 778. The data is found invalid at block 780. Therefore, server 200 cancels the operation as illustrated at block 782 so that activity of the bot 105 is blocked as illustrated at block 784.

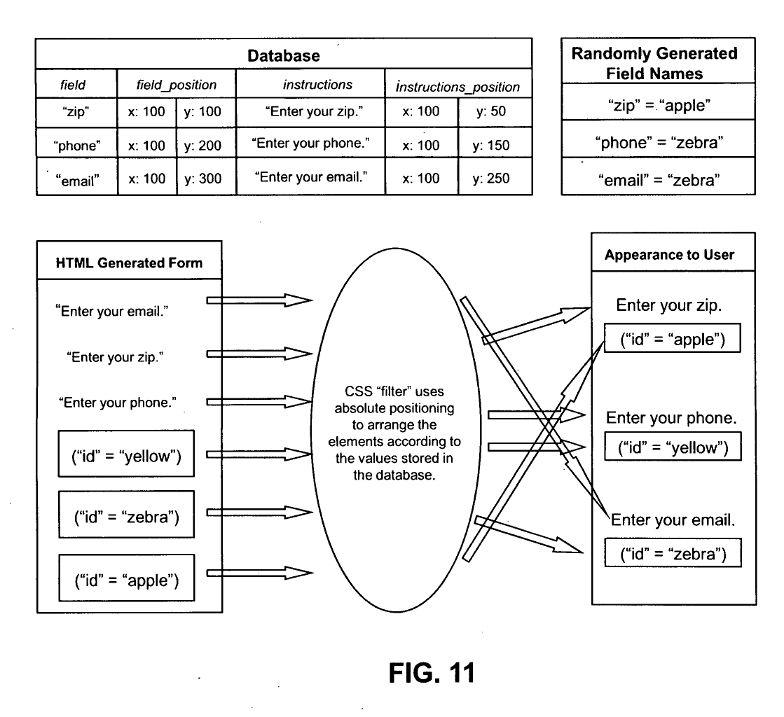

In an illustrated embodiment, cascading style sheets (CSS) may be used to separate presentation order from HTML code order. CSS are used to display the fields in the correct order for users, while the HTML code is randomized to confuse bots 105. FIG. 11 is an example of how a randomly organized code for generating an electronic form is reorganized so that the form looks the same to the user regardless of the random order of the underlying code.

The generated computer code that is shuffled may also include other files extensions which use HTML, a more general form of XML, or any format that can handle field and form data. The shuffled code may also be generated from different file types such as asp, jsp, dhtml, java or C# classes, or the like. XML may be used in technologies like AJAX which could still transmit forms and fields. In addition, similar techniques could apply to Flash based forms. In other words, the features of the present system and method are not limited to HTML files. Likewise, CSS are not the only technology for arranging the form fields on a display. Javascript and other suitable technologies may also be used for the display arrangement discussed herein.

Additional obfuscation may be used in accordance with the present system and method. In another embodiment, pictures may be dynamically generated with the instruction text in them. Optical character recognition (OCR) would be required for the bot to read these instructions. The captions on the pictures may be random and misleading.

In yet another embodiment, arrows may be used to point to a field that correlates with an instruction. Therefore, an instruction may be displayed at the top of a page with an arrow pointing to a form field to enter the information. For example, the instruction “Enter your email.” may be provided with an arrow pointing to the form field where the email address belongs. The next instruction may say, “Enter your zip” with a different arrow pointing to a different field where the zip code should be entered. Such visual linking of instructions and fields using arrows, or other suitable visual indicators, is harder for bots to follow that humans.

In other embodiments, fields could be broken into a multiple forms on the same page. The human user won't know there are multiple forms, but different fields could go in different forms each time. In addition, a random number of unused fields may be inserted into forms. These unused fields may be made not visible using CSS or javascript. The number and names of these unused fields could change with each page load, confusing a bot.

Throughout this application information is sent between at least two computing devices. It is understood, that the sending computing device has a copy of the message stored in a memory accessible by the sending computing device and that the receiving computing device also has a copy of the message stored in a memory accessible by the receiving computing device. It is not required that a complete copy be stored before portions are sent, nor is it a requirement that a complete copy be received before the information therein may be used.

Although the invention has been described in detail with reference to certain preferred embodiments, variations and modifications exist within the spirit and scope of the invention as described and defined in the following claims.

1. A method of managing access to at least one of accounts, information, products and services provided by a computer server to a plurality of computing devices communicating with the server over a network, the method comprising:
receiving a request from a computing device at the server;
automatically identifying a plurality of form fields for an electronic form with the server in response to the request, the plurality of form fields allowing a user of the computing device to input information for submission to the server;
automatically arranging the plurality of form fields in a random order with the server;
automatically creating and sending the electronic form from the server to the computing device, the electronic form including the plurality of form fields arranged in the random order;
receiving a plurality of inputs corresponding to the plurality of form fields from the computing device at the server; and
automatically determining with the server whether the plurality of inputs corresponding to the plurality of form fields received from the computing devices are valid.

2. The method of claim 1, wherein the plurality of inputs corresponding to the plurality of form fields received from the computing device are determined to be valid by the server if the plurality of inputs have input characteristics that match expected input characteristics for corresponding form fields.

3. The method of claim 1, wherein the plurality of inputs corresponding to the plurality of form fields received from the computing device are determined to be invalid by the server if at least one input has an input characteristic that is different from an expected input characteristic for a corresponding form field.

4. The method of claim 1, wherein the plurality of form fields provide at least one of a text field, a drop-down menu, a radio button, and a checkbox in the electronic form to allow a user of the computing device to input information for submission to the server.

5. The method of claim 1, further comprising:
automatically assigning a randomly generated name to each of the plurality of form fields with the server;
automatically mapping and storing the randomly generated names to the corresponding form fields in a memory of the server; and
using the mapped randomly generated names during the step of automatically determining with the server whether the plurality of inputs corresponding to the plurality of form fields received from the computing device are valid.

6. The method of claim 5, further comprising deleting the stored randomly generated names from the memory of the server after using step.

7. The method of claim 1, further comprising automatically creating an account with the server based on information contained in the plurality of inputs if the plurality of inputs are valid.

8. The method of claim 7, further comprising storing the random order of the form fields for the electronic form for a valid account in a memory of the server, and using the stored order of the form fields when the same electronic form is subsequently sent by the server to a computing device using a valid account.

9. The method of claim 1, further comprising denying access by the computing device to at least one of accounts, information, products and services provided by the server if the plurality of inputs are invalid.

10. The method of claim 1, further comprising permitting access by the computing device to at least one of accounts, information, products and services provided by the server if the plurality of inputs are valid.

11. The method of claim 1, wherein the plurality of forms fields has an associated instruction, and wherein an order of the instructions is automatically arranged by the server to match the random order of the form fields during the step of automatically creating and sending the electronic form from the server to the computing device.

12. The method of claim 11, further comprising transmitting display instructions from the server to the computing device to permit the computing device to display the electronic form with form fields and related instructions in a matching order.

13. The method of claim 1, further comprising maintaining related form fields together in the electronic form during the step of automatically creating and sending the electronic form from the server to the computing device.

14. The method of claim 1, wherein each form field has a corresponding computer code for generating the electronic form, and further comprising shuffling an order of the corresponding computer code with the server so that a displayed order of the form fields on the computing device is different than an order of the computer code corresponding to the form fields.

15. The method of claim 14, wherein the computer code is an HTML file.

16. The method of claim 15, wherein cascading style sheets are used to display form fields on the computing device.

17. The method of claim 1, wherein a plurality of pictures having instructions corresponding to the plurality of form fields are dynamically generated by the server and sent to the computing device as part of the electronic form.

18. The method of claim 1, wherein the plurality of forms fields have corresponding instructions, and wherein a visual indicator is provided by the server to link the form fields to the corresponding instructions on a display of the computing device.

19. The method of claim 1, wherein a random number of unused fields are inserted into the electronic form by the server, and wherein the unused fields are not displayed in the electronic form on the computing device.

20. A method of managing access to at least one of accounts, information, products and services provided by a computer server to a plurality of computing devices communicating with the server over a network, the method comprising:
receiving a request from a first computing device at the server;
automatically creating and sending an electronic form from the server to the first computing device in response to the request received from the first computing device, the electronic form including a plurality of form fields arranged in a first order;
receiving a request from a second computing device at the server;
automatically creating and sending the electronic form from the server to the second computing device in response to the request received from the second computing device, the electronic form including the same plurality of form fields arranged in a second order different from the first order;
receiving a plurality of inputs corresponding to the plurality of form fields from the first and second computing devices at the server; and
automatically determining with the server whether the plurality of inputs corresponding to the plurality of form fields received from the first and second computing devices are valid.

21. The method of claim 20, wherein the plurality of inputs corresponding to the plurality of form fields received from the first and second computing devices are determined to be valid by the server if the plurality of inputs have input characteristics that matches expected input characteristics for corresponding form fields.

22. The method of claim 20, wherein the plurality of inputs corresponding to the plurality of form fields received from the first and second computing devices are determined to be invalid by the server if at least one input has an input characteristic that is different from an expected input characteristic for a corresponding form field.

23. The method of claim 20, wherein the plurality of form fields allow users of the first and second computing devices to input information for submission to the server.

24. The method of claim 20, wherein the plurality of form fields provide at least one of a text field, a drop-down menu, a radio button, and a checkbox in the electronic form to allow users at the first and second computing devices to input information for submission to the server.

25. The method of claim 20, further comprising:
automatically assigning a randomly generated name to each of the plurality of form fields with the server;
automatically mapping and storing the randomly generated names to the corresponding form fields in a memory of the server; and
using the mapped randomly generated names during the step of automatically determining with the server whether the plurality of inputs corresponding to the plurality of form fields received from the first and second computing devices are valid.

26. The method of claim 20, wherein the plurality of forms fields have an associated instruction, and wherein an order of the instructions is automatically arranged by the server to match the random order of the form fields during the step of automatically creating and sending the electronic form from the server to the first and second computing devices.

27. The method of claim 20, wherein each form field has a corresponding computer code for generating the electronic form, and further comprising shuffling an order of the corresponding computer code with the server so that a displayed order of the form fields on the first and second computing devices is different than an order of the computer code corresponding to the form fields.

28. The method of claim 20, wherein the steps of automatically creating and sending an electronic form from the server to the first and second computing devices in response to the requests received from the first and second computing devices, respectively, comprises automatically identifying a plurality of form fields for an electronic form with the server in response to the requests, and automatically arranging the plurality of form fields in a random order with the server.

29. A system for managing access to at least one of accounts, information, products and services by a plurality of computing devices which are connectable to a network, the system comprising:
a computer server operatively connected to the plurality of computing devices through the network;
a memory accessible by the server; and
at least one access management application stored in the memory, the at least one access management application controlling the server to automatically identify a plurality of form fields for an electronic form in response to a request from a computing device, the plurality of form fields allowing a user of the computing device to enter information for submission to the server, to automatically arrange the plurality of form fields in a random order, to automatically create and send the electronic form from the server to the computing device, the electronic form including the plurality of form fields arranged in the random order, to receive a plurality of inputs corresponding to the plurality of form fields from the computing device, and to automatically determine whether the plurality of inputs corresponding to the plurality of form fields received from the computing devices are valid.

30. The system of claim 29, wherein the plurality of inputs corresponding to the plurality of form fields received from the computing device are determined to be valid by the server if the plurality of inputs have input characteristics that match expected input characteristics for corresponding form fields, and the plurality of inputs corresponding to the plurality of form fields received from the computing device are determined to be invalid by the server if at least one input has an input characteristic that is different from an expected input characteristic for a corresponding form field.

31. The system of claim 29, wherein the plurality of form fields provide at least one of a text field, a drop-down menu, a radio button, and a checkbox in the electronic form to allow a user of the computing device to input information for submission to the server.

32. The system of claim 29, wherein the at least one access management application further controls the server to automatically assign a randomly generated name to each of the plurality of form fields, to automatically map and store the randomly generated names to the corresponding form fields in the memory, and to use the mapped randomly generated names to automatically determine whether the plurality of inputs corresponding to the plurality of form fields received from the first and second computing devices are valid.

33. The system of claim 29, wherein the at least one access management application further controls the server to automatically create an account based on information contained in the plurality of inputs if the plurality of inputs are valid, to store the random order of the form fields for the electronic form for a valid account in the memory, and to use the stored order of the form fields when the same electronic form is subsequently sent to a computing device using the valid account.

34. The system of claim 29, wherein the plurality of forms fields have an associated instruction, and wherein the at least one access management application further controls the server to automatically arrange an order of the instructions to match the random order of the form fields.

35. The system of claim 29, wherein each form field has a corresponding computer code for generating the electronic form, and wherein the at least one access management application further controls the server shuffle an order of the corresponding computer code so that a displayed order of the form fields on the computing device is different than an order of the computer code corresponding to the form fields.

36. The system of claim 29, wherein the at least one access management application further controls the server to generate and send a plurality of pictures having instructions corresponding to the plurality of form fields to the computing device as part of the electronic form.

37. The system of claim 29, wherein the plurality of forms fields have corresponding instructions, and wherein the at least one access management application further controls the server to provide a visual indicator to link the form fields to the corresponding instructions on a display of the computing device.

38. The system of claim 29, wherein the at least one access management application further controls the server to insert a random number of unused fields into the electronic form configured so that the unused fields are not displayed in the electronic form on the computing device.
